(19) United States
(12) Patent Application Publication
(10) Pub. No.: US 2026/0135472 A1
(43) Pub. Date: May 14, 2026

(54) INVERTER CONTROL APPARATUS

(71) Applicant: HITACHI ASTEMO, LTD., Hitachinaka-shi, Ibaraki (JP)

(72) Inventor: Masayoshi KASHIHARA, Hitachinaka-shi, Ibaraki (JP)

(73) Assignee: HITACHI ASTEMO, LTD., Hitachinaka-shi, Ibaraki (JP)

(21) Appl. No.: 18/993,275

(22) PCT Filed: Jul. 15, 2022
(86) PCT No.: PCT/JP2022/027933

§ 371 Date: Jan. 10, 2025

(51) Int. Cl. H02M 1/32; H02M 7/537

(52) U.S. Cl. CPC H02M 1/327; H02M 7/537

(57) ABSTRACT

An inverter control apparatus includes: a plurality of temperature sensing elements provided in correspondence to a plurality of switching elements; a temperature detection circuit that receives a detection signal from each of the temperature sensitive elements and that outputs temperature detection information; a control unit that calculates a temperature of each of the switching elements, based on the temperature detection information; and
a switching circuit that switches the detection signal from each of the temperature sensing elements and that outputs the switched detection signal to the temperature detection circuit. The control unit operates the switching circuit to select the detection signal to be outputted from the temperature sensing element to the temperature detection circuit.

### TECHNICAL FIELD

The present invention relates to an inverter control apparatus.

### BACKGROUND ART

A temperature detection system using a temperature sensing element, such as a temperature sensing diode, is provided with a temperature detection circuit that outputs a detection signal from the temperature sensing element to a control unit, such as a microcomputer. For example, in an inverter, temperature sensing elements are disposed on a high-voltage side, and a control unit, such as a microcomputer that monitors temperature detection information, is disposed on a low-voltage side. In addition, in correspondence to the plurality of temperature sensing elements, a plurality of temperature detection circuits, which include circuits that separate the temperature sensing elements from the control unit via insulating elements, are provided.

Patent Literature 1 discloses an inverter in which in corresponding to switching elements, temperature sensing diodes that detect temperatures of the switching elements are provided, and, in correspondence to each of the temperature sensing diodes, a temperature detection circuit composed of a voltage detection circuit, a pulse signal output circuit, a photocoupler, and the like is provided.

### CITATION LIST

### Patent Literature

PTL 1: JP 2013-250175 A

### SUMMARY OF INVENTION

### Technical Problem

According to the inverter described in Patent Literature 1, a plurality of temperature detection circuits need to be provided in correspondence to a plurality of temperature sensing elements, and therefore a configuration of an inverter control apparatus becomes complicated.

### Solution to Problem

An inverter control apparatus according to the present invention includes: a plurality of temperature sensing elements provided in correspondence to a plurality of switching elements; a temperature detection circuit that receives a detection signal from each of the temperature sensitive elements and that outputs temperature detection information; a control unit that calculates a temperature of each of the switching elements, based on the temperature detection information; and a switching circuit that switches the detection signal from each of the temperature sensing elements and that outputs the switched detection signal to the temperature detection circuit. The control unit operates the switching circuit to select the detection signal to be outputted from the temperature sensing element to the temperature detection circuit.

### Advantageous Effects of Invention

According to the present invention, the configuration of the inverter control apparatus can be simplified.

### BRIEF DESCRIPTION OF DRAWINGS

FIG. 1 is a circuit configuration diagram of an inverter control apparatus according to a first embodiment.

FIGS. 2(a) to 2(f) are timing charts showing first switching of temperature sensing elements.

FIGS. 3(a) to 3(f) are timing charts showing second switching of the temperature sensing elements.

FIG. 4 is a circuit configuration diagram of an inverter control apparatus according to a second embodiment.

FIGS. 5(a) to 5(e) are timing charts showing switching of temperature sensing elements of the second embodiments.

FIG. 6 is a circuit configuration diagram of an inverter control apparatus according to a third embodiment.

FIGS. 7(a) to 7(h) are timing charts showing switching of ground potential supply elements according to the third embodiment.

### DESCRIPTION OF EMBODIMENTS

Hereinafter, embodiments of the present invention will be described with reference to the drawings. The following description and drawings are examples for describing the present invention, and are partially omitted or simplified when necessary to make the description clear. The present invention can be implemented in various other forms. Unless otherwise specified, each constituent element may be provided as a singular element or as plural elements as well.

A position, size, shape, range, and the like of each constituent element shown in drawings may not represent the actual position, size, shape, ranges, and the like of the constituent element. This is done for the purpose of facilitating understanding of the invention. The present invention, therefore, is not necessarily limited by positions, sizes, shapes, ranges, and the like shown in the drawings.

### First Embodiment

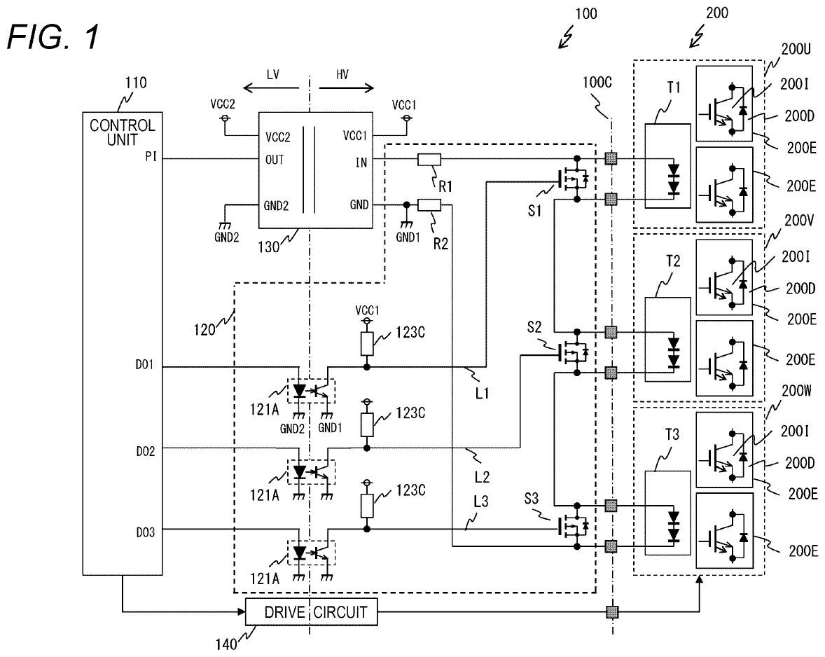

FIG. 1 is a circuit configuration diagram of an inverter control apparatus 100 according to a first embodiment of the present invention.

The inverter control apparatus 100 is connected to a power module 200 and controls/drives the power module 200.

The power module 200 includes a U-phase power module 200U, a V-phase power module 200V, and a W-phase power module 200W.

The U-phase power module 200U includes switching elements 200E making up an upper arm and a lower arm, respectively. Each switching element 200E is composed of an IGBT200I and a diode 200D. A temperature sensing element T1 is provided in correspondence to the switching element 200E of the upper arm or the lower arm. The U-phase power module 200U is constructed by placing the switching element 200E of the upper arm, the switching element 200E of the lower arm, and the temperature sensing element T1 in one package and sealing the package with a resin material. In the same manner, the V-phase power module 200V is constructed by placing the switching element 200E of the upper arm, the switching element 200E of the lower arm, and the temperature sensing element T2 in one package. In the same manner, the W-phase power module 200W is constructed by placing the switching element 200E of the upper arm, the switching element 200E of the lower arm, and the temperature sensing element T3 in one package.

The switching element 200E is a power semiconductor device, which is an insulated gate bipolar transistor (IGBT) or may be a metal oxide semiconductor field-effect transistor (MOSFET), and is provided with the diode 200D when necessary. The power module 200 of a 2-in-1 structure, in which the upper arm and the lower arm are integrated into one module, will be described as an example. The power module 200, however, may have a different structure, e.g., a structure in which a plurality of upper arms and lower arms are integrated into one module.

The U-phase power module 200U, the V-phase power module 200V, and the W-phase power module 200W are connected to a three-phase bridge circuit to constitute an inverter. By inputting a drive signal to the gate terminal of the IGBT200I, the switching element 200E is switched on and off, which converts a DC voltage inputted between the positive electrode side and the negative electrode side of the power module 200 into AC power. The converted AC power is supplied from connection ends of the upper arm and the lower arm to coils of three phases of a motor (not illustrated). This drives the motor.

The inverter control apparatus 100 includes a control unit 110, a switching circuit 120, a temperature detection circuit 130, and a drive circuit 140.

On a board, the inverter control apparatus 100 is electrically separated into a high-voltage side HV and a low-voltage side LV. The high-voltage side HV of the inverter control apparatus 100 is connected to the power module 200 via connection portions 100C, such as connectors. The control unit 110 is disposed on the low-voltage side LV of the inverter control apparatus 100. The switching circuit 120, the temperature detection circuit 130, and the drive circuit 140 are each electrically separated into the high-voltage side HV and the low-voltage side LV inside of the switching circuit 120, temperature detection circuit 130, and drive circuit 140, where electric signals are sent/received to/from each other via insulating elements.

The control unit 110, which is a microcomputer or a central processing unit (CPU), generates a drive signal for driving the power module 200, according to a torque instruction inputted from a higher-order controller (not illustrated). To detect a state of the power module 200, the control unit 110 detects a temperature of the power module 200. When detecting the temperature, the control unit 110 outputs instruction signals DO1, DO2, and DO3 to the switching circuit 120, which will be described later, to actuate the switching circuit 120, thus selecting a detection signal that each of the temperature sensing elements T1, T2, and T3 outputs to the temperature detection circuit 130, which will be described later. The control unit 110 then calculates a temperature of the switching element 200E, based on temperature detection information inputted from the temperature detection circuit 130 to an input end PI.

According to the instruction signals DO1, DO2, and DO3, the switching circuit 120 switches detection signals from the temperature sensing elements T1, T2, and T3, which are selection targets. Specifically, by switching current paths of currents supplied to the temperature sensing elements T1, T2, and T3, which are the selection targets, according to the instruction signals DO1, DO2, and DO3, the detection signals from the temperature sensing elements T1, T2, and T3 are switched.

The instruction signals DO1, DO2, and DO3 outputted from the control unit 110 are inputted to insulating elements 121A, respectively. Each insulating element 121A is, for example, a photocoupler constructed by sealing a light-emitting element and a light-receiving element in one package. A ground of the light-emitting element is connected to a ground GND2 on the low-voltage side LV, while a ground of the light-receiving element is connected to a ground GND1 on the high-voltage side HV. Output lines L1, L2, and L3 to switchover elements S1, S2, and S3, the output lines L1, L2, and L3 being on the light-receiving element side, are supplied with a voltage VCC1 of the high-voltage side HV via resistances 123C. The switchover elements S1, S2, and S3 are switched on when the voltage VCC1 is supplied to their gates, and are switched off when the voltage VCC1 is not supplied to the gates. The switchover elements S1, S2, and S3 are connected in parallel to the temperature sensing elements T1, T2, and T3 for three phases provided in the power module 200, respectively.

The temperature sensing elements T1, T2, and T3 for three phases provided in the power module 200 are connected in series on a current path, and to one end of the serially connected temperature sensing elements T1, T2, and T3, a constant current from a terminal IN of the temperature detection circuit 130 is supplied via an offset resistor R1. The other end of the serially connected temperature sensing elements T1, T2, and T3 is connected to a terminal GND of the temperature detection circuit 130 via an offset resistance R2. The terminal GND is connected to the ground GND1 of the high-voltage side HV.

The temperature detection circuit 130 detects a voltage across the terminal IN and the terminal GND as a detection signal from one of the temperature sensing elements T1, T2, and T3, converts the detected voltage into a duty wave corresponding the detected voltage, and outputs the duty wave as temperature detection information, from an OUT terminal to the control unit 110. The offset resistances R1 and R2 are provided for the purpose of setting an offset range for the voltage across the terminal IN and the terminal GND and keeping the voltage within a range of input voltage specifications of the temperature detection circuit 130. The control unit 110 converts the duty wave outputted from the temperature detection circuit 130, into a voltage, and calculates a temperature, referring to voltage-temperature characteristics of the temperature sensing elements T1, T2, and T3 that are stored in advance. What is described above is the example in which the temperature detection circuit 130 outputs the duty wave as the temperature detection information. However, the duty wave may be other form of information that the control unit 110 can understand.

The drive circuit 140 switches on and off the switching element 200E in the power module 200, based on a drive signal from the control unit 110.

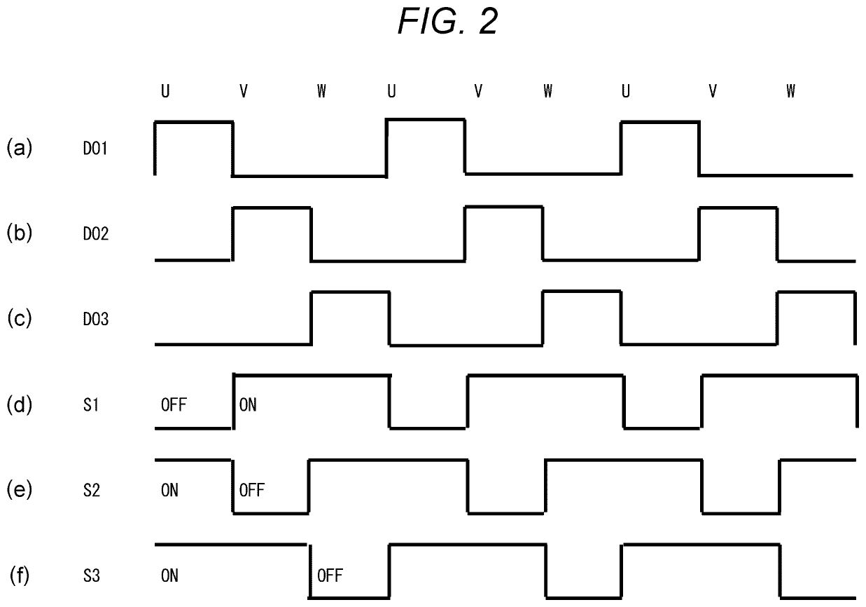

FIGS. 2(a) to 2(f) are timing charts showing first switching of the temperature sensing elements T1, T2, and T3. FIGS. 2(a) to 2(c) are timing charts of the instruction signals DO1, DO2, and DO3, and FIGS. 2(d) to 2(f) are timing charts of the switchover elements S1, S2, and S3.

As shown in FIGS. 2(a) to 2(c), the control unit 110 outputs the instruction signals DO1, DO2, and DO3 for sequentially selecting one of the temperature sensing elements T1, T2, and T3 of the U-phase power module 200U, the V-phase power module 200 V, and the W-phase power module 200 W. In response to the instruction signals DO1, DO2, and DO3, the switching circuit 120 operates to switch on/off the switchover elements S1, S2, and S3, as shown in FIGS. 2(d) to 2(f).

For example, at a point of time at which the switchover element S1 is off as the switchover elements S2 and S3 are on, current is supplied only to the temperature sensing element T1 of the U-phase power module 200U. As a result, at this point of time, the temperature sensing element T1 of the U-phase power module 200U becomes an operating state. The temperature detection circuit 130 detects a voltage across the terminal IN and the terminal GND, that is, the sum of a voltage of the temperature sensing element T1, a voltage of the offset resistance R1, and a voltage of the offset resistance R2, converts the detected voltage into a duty wave corresponding to the detected voltage, and outputs the duty wave from the OUT terminal to the control unit 110. The control unit 110 converts the duty wave detected at this point of time into a voltage, and calculates a temperature, referring to voltage-temperature characteristics of the temperature sensing element T1. This calculated temperature is taken to be a detection temperature of the U-phase power module 200U. In the same manner, a temperature of the V-phase power module 200 V is calculated at a point of time at which the switchover element S2 is off as the switchover elements S1 and S3 are on, and a temperature of the W-phase power module 200 W is calculated at a point of time at which the switchover element S3 is off as the switchover elements S1 and S2 are on.

According to the first switching of the temperature sensing elements T1, T2, and T3 of this embodiment, respective temperatures of the power modules 200 of three phases can be detected as the switchover elements S1, S2, and S3 are switched on and off. This allows one temperature detection circuit 130 to perform temperature detection for three phases, which simplifies the configuration of the inverter control apparatus 100, compared with a case where three temperature detection circuits 130 are provided for three phases, thus reducing costs the configuration requires. In the case of providing three temperature detection circuits 130 for three phases, the temperature sensing elements T1, T2, and T3 constantly carry current flows. However, according to this embodiment, the switching action of the switching circuit 120 reduces a period of current's flowing in the temperature sensing elements T1, T2, and T3 to ⅓. Hence the service life of the temperature sensing elements T1, T2, and T3 can be extended, and the reliability of the temperature sensing elements T1, T2, and T3 and that of temperature detection can be improved. Furthermore, in the case of providing three temperature detection circuits 130 for three phases, a different current is supplied to each of the temperature sensing elements T1, T2, and T3 for each phase. According to this embodiment, however, a supplied current is used in common, which eliminates a current variation between different phases, thus improving the accuracy of temperature detection.

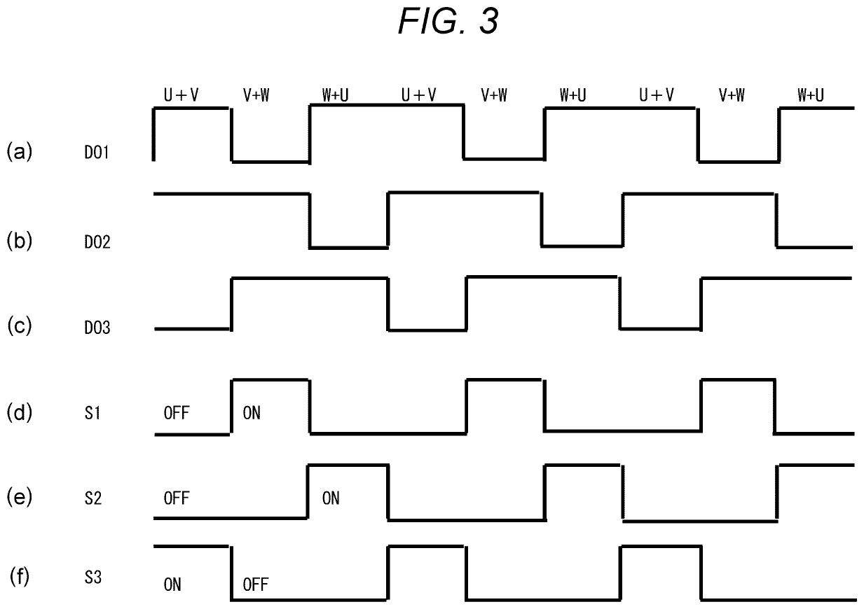

FIGS. 3(a) to 3(f) are timing charts showing second switching of the temperature sensing elements T1, T2, and T3. FIGS. 3(a) to 3(c) are timing charts of the instruction signals DO1, DO2, and DO3, and FIGS. 3(d) to 3(f) are timing charts of the switchover elements S1, S2, and S3.

As shown in FIGS. 3(a) to 3(c), the control unit 110 outputs the instruction signals DO1, DO2, and DO3 for sequentially selecting two (two phases) of the temperature sensing elements T1, T2, and T3 of the U-phase power module 200U, the V-phase power module 200 V, and the W-phase power module 200 W. In response to these instruction signals DO1, DO2, and DO3, the switching circuit 120 operates to switch on and off the switchover elements S1, S2, and S3, as shown in FIGS. 3(d) to 3(f).

For example, when the temperature sensing elements T1 and T2 of the U-phase power module 200U and V-phase power module 200V are selected respectively, the switchover elements S1 and S2 are switched off as the switchover element S3 is switched on. At this point of time, a current is supplied to respective temperature sensing elements T1 and T2 of the U-phase power module 200U and the V-phase power module 200 V, and no current is supplied to the temperature sensing element T3 of the W-phase power module 200 W.

As a result, at this point of time, the temperature detection circuit 130 detects a voltage across the terminal IN and the terminal GND, that is, the sum of a voltage of the temperature sensing elements T1 and T2 connected in series, a voltage of the offset resistance R1, and a voltage of offset resistance R2. The temperature detection circuit 130 then converts the detected voltage into a duty wave corresponding to the detected voltage, and outputs the duty wave from the OUT terminal to the control unit 110. The control unit 110 converts the duty wave detected at this point of time into a voltage, and calculates temperatures, referring to voltage-temperature characteristics of the temperature sensing elements T1 and T2. Then, from these temperatures, an average detection temperature of the U-phase power module 200U and the V-phase power module 200V is calculated. An average detection temperature of the V-phase power module 200V and the W-phase power module 200W and an average detection temperature of the W-phase power module 200W and the U-phase power module 200U are also calculated in the same manner.

According to the second switching of the temperature sensing elements T1, T2, and T3 of this embodiment, the configuration of the inverter control apparatus 100 can be simplified, compared with the case where three temperature detection circuits 130 are provided for three phases, and therefore costs the configuration requires are reduced in the same manner as in the case of the first switching. In addition, the switching action of the switching circuit 120 reduces a period of current's flowing in the temperature sensing elements T1, T2, and T3 to ⅔. Hence the service life of the temperature sensing elements T1, T2, and T3 can be extended, and the reliability of the temperature sensing elements T1, T2, and T3 can be improved as well. Furthermore, a supplied current is used in common. This eliminates a current variation between different phases, thus improving the accuracy of temperature detection.

An example in which the first switching and the second switching of the temperature sensing elements T1, T2, and T3 are used in combination will be described. In the following description, the current value of a current supplied to the temperature sensing elements T1, T2, and T3 is denoted as I, and the resistance value of the offset resistance R1 and that of offset resistance R2 are each denoted as R.

In an assumed case where in the first switching, the U-phase temperature sensing element T1 has a voltage Vf(U), the V-phase temperature sensing element T2 has a voltage Vf (V), and the W-phase temperature sensing element T3 has a voltage Vf (W), a voltage across the terminal IN and the terminal GND of the temperature detection circuit 130 for one-phase selection is given by each of the following equations (1), (2), and (3).

$$Vf ( U ) + 2 IR \qquad ( 1 )$$

$$Vf ( V ) + 2 IR \qquad ( 2 )$$

$$Vf ( W ) + 2 IR \qquad ( 3 )$$

The temperature detection circuit 130 outputs duty waves equivalent to voltages given by equations (1), (2), and (3), to the control unit 110. The control unit 110 converts the duty waves into voltages and adds up the voltages of three phases to calculate a value A, as indicated by the following equation (4).

$$A = Vf ( U ) + Vf ( V ) + Vf ( W ) + 6 IR \qquad ( 4 )$$

In the second switching, on the other hand, the voltage across the terminal IN and the terminal GND of the temperature detection circuit 130 for two-phase selection is given by each of the following equations (5), (6), and (7).

$$Vf ( U ) + Vf ( V ) + 2 IR \qquad ( 5 )$$

$$Vf ( V ) + Vf ( W ) + 2 IR \qquad ( 6 )$$

$$Vf ( W ) + Vf ( U ) + 2 IR \qquad ( 7 )$$

The temperature detection circuit 130 outputs duty waves equivalent to voltages given by equations (5), (6), and (7), to the control unit 110. The control unit 110 converts the duty waves into voltages and adds up the voltages of three phases to calculate a value B, as indicated by the following equation (8).

$$B = 2 Vf ( U ) + 2 Vf ( V ) + 2 Vf ( W ) + 6 IR \qquad ( 8 )$$

The control unit 110 repeats the first switching and the second switching of the temperature sensing elements T1, T2, and T3 at every cycle of a given time. Alternatively, the control unit 110 executes the first switching in a normal situation, and when the need of obtaining the voltage IR of each of the offset resistances R1 and R2 arises, executes the second switching for only a given time Then, the obtained values A and B are applied to the following equation (9) to calculate the voltage IR of each of the offset resistances R1 and R2.

$$IR = ( 2 * A - B ) / 6 \qquad ( 9 )$$

Then, by subtracting 2IR from each of the voltages given by the equations (1), (2), and (3), that is, by excluding the voltages of the offset resistances from the equations (1), (2), and (3), Vf(U), Vf(V), and Vf(W) are obtained, and temperatures are calculated, referring to respective voltage-temperature characteristics of the temperature sensing elements T1, T2, and T3. The voltage-temperature characteristics of the temperature sensing elements T1, T2, and T3 in this case are the voltage-temperature characteristics not including the voltages of the offset resistances, and therefore do not undergo the influence of variations in the offset resistances.

It should be noted that third switching, by which the temperature sensing elements T1, T2, and T3 of three phases are selected, may be carried out properly for a given time to obtain the voltage IR of each of the offset resistances R1 and R2. In this case, a value C given by the following equation (10) is obtained.

$$C = Vf ( U ) + Vf ( V ) + Vf ( W ) + 2 IR \qquad ( 10 )$$

Then, the obtained value C and the value A given by equation (4) are applied to the following equation (11) to calculate the voltage IR of each of the offset resistances R1 and R2.

$$IR = ( A - C ) / 4 \qquad ( 11 )$$

The example of this embodiment in which the voltage of the offset resistances is excluded offers the same effects as the effects of the first switching and second switching, and additionally offers an effect of eliminating the influence of the offset resistances, thus allowing highly accurate temperature detection.

### Second Embodiment

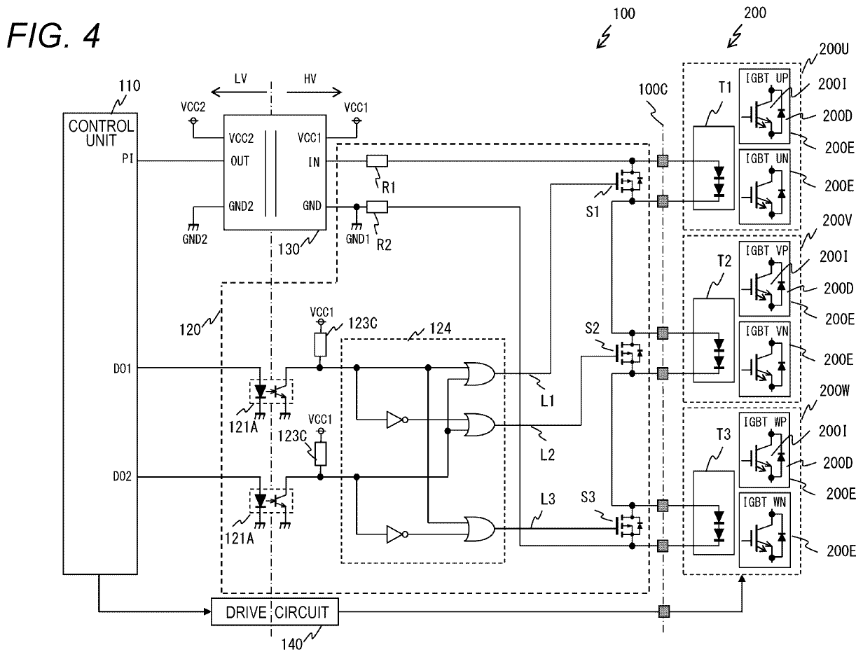

FIG. 4 is a circuit configuration diagram of an inverter control apparatus 100 according to a second embodiment of the present invention. In the first embodiment, the control unit 110 outputs the instruction signals DO1, DO2, and DO3 to the switching circuit 120 through three signal lines when carrying out temperature detection. In the second embodiment, in contrast, the control unit 110 outputs the instruction signals DO1 and DO2 through two signal lines. The same components as shown in FIG. 1 are denoted by the same reference signs, and description thereof will be simplified.

As shown in FIG. 4, the instruction signals DO1 and DO2 are inputted to a logic circuit 124. The logic circuit 124 is a decoder circuit logically configured by an OR gate, a NOT gate, and the like, and outputs signals to the three output lines L1, L2, and L3 according to combinations of two incoming signals, i.e., the instruction signals DO1 and DO2. The output lines L1, L2, and L3 are connected to the gates of the switchover elements S1, S2, and S3, respectively. In this example, the instruction signals DO1 and DO2 causes the temperature sensing elements T1, T2, and T3 to switch on and off in the timing of the first switching.

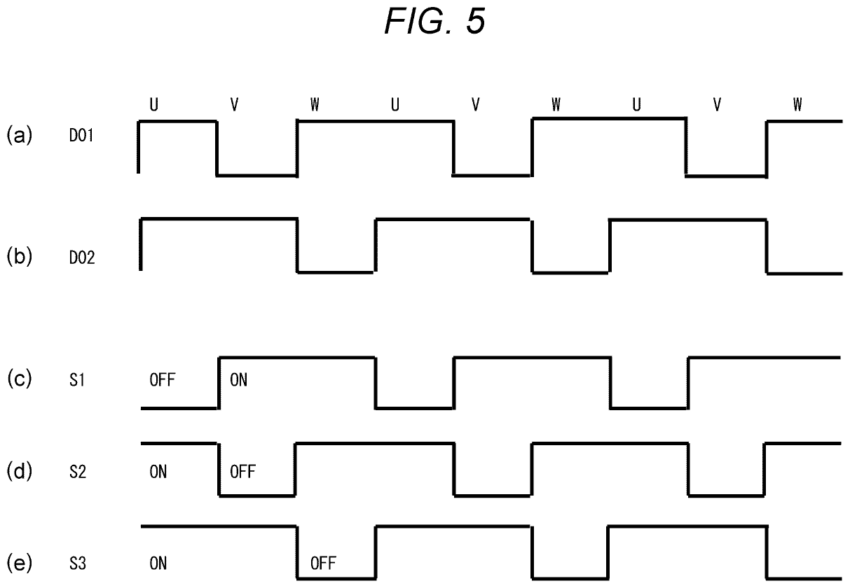

FIGS. 5(a) to 5(e) are timing charts showing switching of the temperature sensing elements T1, T2, and T3 of the second embodiments. FIGS. 5(a) and 5(b) are timing charts of the instruction signals DO1 and DO2, and FIGS. 5(c) to 5(e) are timing charts of the switchover elements S1, S2, and S3.

For example, in the first switching, any one of the switchover elements S1, S2, and S3 is switched off as the other two are switched on, as shown in FIGS. 5(c) to 5(e). The switchover elements S1, S2, and S3 are switched on and off according to combinations of the two instruction signals DO1 and DO2.

This embodiment offers the same effects as the effects of the first switching of the first embodiment, and additionally offers an effect of reducing the number of output terminals of the control unit 110 composed of a microcomputer or the like and reducing the number of the insulating elements 121A as well, thus allowing configuration simplification and cost reduction.

### Third Embodiment

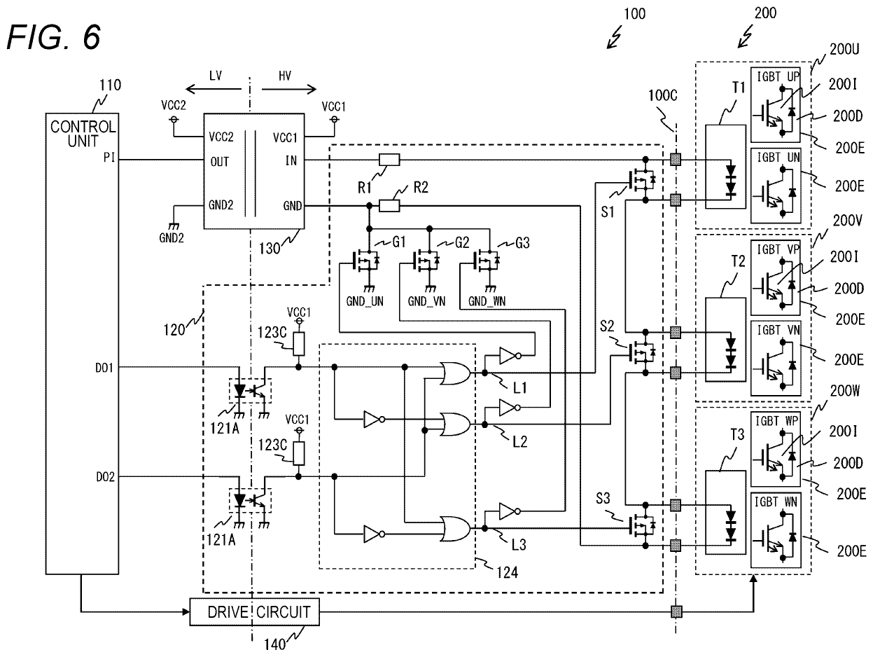

FIG. 6 is a circuit configuration diagram of an inverter control apparatus 100 according to a third embodiment of the present invention. In the first embodiment and the second embodiment, the temperature detection circuit 130 detects a voltage across the terminal IN and the terminal GND, and the terminal GND has its potential matched to a ground potential on the high-voltage side HV. In this embodiment, the terminal GND has its potential matched to a ground-side potential of a power module corresponding to a switchover element switched off. The same components as shown in FIGS. 1 and 2 are denoted by the same reference signs and description thereof will be simplified.

As shown in FIG. 6, the terminal GND of the temperature detection circuit 130 is connected to grounds GND_UN, GND_VN, and GND_WN via ground potential supply elements G1, G2, and G3, respectively. The grounds GND_UN, GND_VN, and GND_WN are equivalent to ground-side potentials (negative-electrode-side potential) of the U-phase power module 200U, the V-phase power module 200V, and the W-phase power module 200W, respectively. A load, such as a motor running on alternating current, is connected to the output side of the power module 200, and, to drive the motor, the ground-side potential (negative-electrode-side potential) of the power module 200 is used.

To the gates of the ground potential supply elements G1, G2, and G3, outputs from the output lines L1, L2, and L3 from the logic circuit 124 are inputted via NOT gates, respectively. The logic circuit 124 is not used in the first embodiment shown in FIG. 1. When the third embodiment is applied to the first embodiment, however, outputs from the output lines L1, L2, and L3 are inputted to the gates of the ground potential supply elements G1, G2, and G3 via the NOT gates.

When the switchover element S1, S2, or S3 has no supply of the voltage VCC1 from the output line L1, L2, or L3 to its gate, such a switchover element S1, S2, or S3 is switched off. A voltage of the temperature sensing element T1, T2, or T3 corresponding to the switchover element S1, S2, or S3 switched off is then detected. In this case, the ground potential supply element G1, G2, or G3 corresponding to the switchover element S1, S2, or S3 switched off is switched on, and the ground GND_UN, GND_VN, or GND_WN corresponding to the ground potential supply element G1, G2, or G3 switched on is connected.

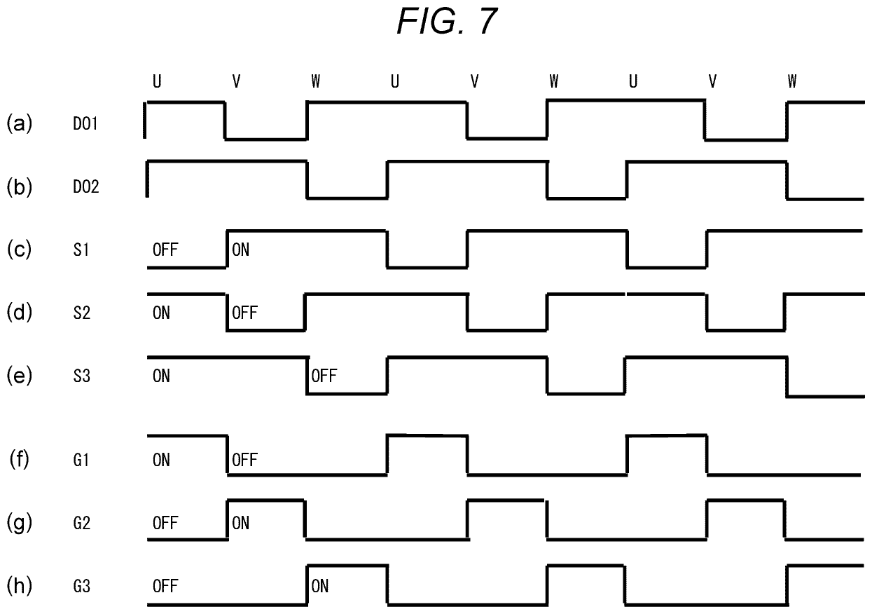

FIGS. 7(a) to 7(h) are timing charts showing switching of the ground potential supply elements G1, G2, and G3 according to the third embodiment. FIGS. 7(a) and 7(b) show timing charts of the instruction signals DO1 and DO2, FIGS. 7(c) to 7(e) show timing charts of the switchover elements S1, S2, and S3, and FIGS. 7(f) to 7(h) show timing charts of the ground potential supply elements G1, G2, and G3.

FIGS. 7(a) to 7(e) are the same as FIGS. 5(a) to 5(e) of the second embodiment, showing the timing of switching on and off the switchover elements S1, S2, and S3 according to the instruction signals DO1 and DO2. As shown in FIGS. 7(f) to 7(h), the ground potential supply element G1, G2, or G3 corresponding to the switchover element S1, S2, or S3 switched off is switched on.

This embodiment offers the same effects as the effects described in the first and second embodiments, and additionally offers an effect of suppressing the influence of potential fluctuations on the output side of the power module 200, thus improving the accuracy of temperature detection.

According to the embodiments described above, the following effects can be obtained.

(1) The inverter control apparatus 100 includes: the plurality of temperature sensing elements T1, T2, and T3 provided in correspondence to the plurality of switching elements 200E; the temperature detection circuit 130 that receives a detection signal from each of the temperature sensitive elements T1, T2, and T3 and that outputs temperature detection information; the control unit 110 that calculates a temperature of each of the switching elements 200E, based on the temperature detection information; and the switching circuit 120 that switches the detection signal from each of the temperature sensing elements T1, T2, and T3 and that outputs the switched detection signal to the temperature detection circuit 130. The control unit 110 operates the switching circuit 120 to select the detection signal to be outputted from each of the temperature sensing elements T1, T2, and T3 to the temperature detection circuit 130. As a result, the configuration of the inverter control apparatus can be simplified.

### (Modification)

According to the present invention, the first to third embodiments described above can be modified and implemented as modifications in the following manner.

(1) Each embodiment has been described as an example in which the switching circuit 120, the temperature detection circuit 130, and the drive circuit 140 are provided as separate circuits independent of each other. Some of these circuits, however, may be incorporated in the same IC circuit. For example, the switching circuit 120, the temperature detection circuit 130, and the drive circuit 140 may be incorporated together in the same IC circuit.

The present invention is not limited to the above-described embodiments, and other modes of the invention that can be conceived within the range of the technical concept of the present invention are also included in the scope of the present invention, providing that such modes do not impair the features of the present invention. In addition, the above-described embodiments and a plurality of modifications may be combined to offer different configurations.

### REFERENCE SIGNS LIST

100 inverter control apparatus
100C connection portion
110 control unit
120 switching circuit
121A insulating element
130 temperature detection circuit
140 drive circuit
200 power module
200U U-phase power module
200V V-phase power module
200W W-phase power module
200E switching element
200I IGBT
200D diode
T1, T2, T3 temperature sensing element
S1, S2, S3 switchover element
R1, R2 offset resistor
DO1, DO2, DO3 instruction signal
HV high-voltage side
LV low-voltage side

1. An inverter control apparatus comprising:
a plurality of temperature sensing elements provided in correspondence to a plurality of switching elements;
a temperature detection circuit that receives a detection signal from each of the temperature sensitive elements and that outputs temperature detection information;
a control unit that calculates a temperature of each of the switching elements, based on the temperature detection information; and
a switching circuit that switches the detection signal from each of the plurality of temperature sensing elements and that outputs the switched detection signal to the temperature detection circuit, wherein
the control unit operates the switching circuit to select the detection signal to be outputted from the temperature sensing element to the temperature detection circuit.

2. The inverter control apparatus according to claim 1, wherein
the plurality of temperature sensing elements are connected to a current path through which a current is supplied, and wherein
the switching circuit switches the current path to the plurality of temperature sensing elements to select supply of the current to each of the temperature sensing element, thereby switching the detection signal.

3. The inverter control apparatus according to claim 2, wherein
the switching circuit includes a switchover element connected in parallel to the temperature sensing element, and wherein
the control unit controls the switchover element to switch the current path.

4. The inverter control apparatus according to claim 3, wherein
the plurality of temperature sensing elements are connected in series on the current path, wherein
when the switchover element is switched on, the switching circuit stops supplying the current to the temperature sensing element corresponding to the switchover element, and when the switchover element is switched off, the switching circuit supplies the current to the temperature sensing element corresponding to the switchover element, and wherein
the control unit switches the switchover element on and off to select the detection signal.

5. The inverter control apparatus according to claim 4, wherein
each of the plurality of switching elements is sealed in each of power modules of three phases, and supplies a ground-side potential of a power module corresponding to the switchover element switched off, as a ground-side potential of the current path.

6. The inverter control apparatus according to claim 5, comprising a ground potential supply element that switches the ground-side potential of the current path.

7. The inverter control apparatus according to claim 3, wherein
the temperature sensing element is supplied with the current via an offset resistance, and wherein
the control unit determines a resistance voltage applied to the offset resistance, based on a voltage applied to each of the temperature sensing elements, the voltage including a voltage of the offset resistance, and on a voltage applied to a plurality of the temperature sensing elements, the voltage including a voltage of the offset resistance, and calculates a temperature of each of the plurality of switching elements, based on the voltage applied to each of the temperature sensitive elements, the voltage being given by excluding the resistance voltage.

8. The inverter control apparatus according to claim 3, wherein
the control unit outputs an instruction signal to the switching circuit, the instruction signal switching a pattern of output of the detection signal, and wherein
the switching circuit includes a logic circuit that switches the switchover element on and off by a combination of the instruction signals.

9. The inverter control apparatus according to claim 3, comprising a drive circuit that drives the plurality of switching elements.
